(19) United States
(12) Patent Application Publication
(10) Pub. No.: US 2026/0338982 A1
(43) Pub. Date: Oct. 29, 2026

(54) LINEAR MOVEOUT CORRECTION AND PHASE-DELAY FOCUSING REVERSE-TIME MIGRATION METHOD FOR TUNNEL SEISMIC DATA

(71) Applicant: Chongqing Jiaotong University, Chongqing (CN)

(72) Inventors: Yuanming LAI, Chongqing (CN); Xinglin LU, Chongqing (CN); Yuanfu ZHOU, Chongqing (CN); Fenglei HAN, Chongqing (CN); Zihan ZHOU, Chongqing (CN); Shiyang LIU, Chongqing (CN)

(73) Assignee: Chongqing Jiaotong University, Chongqing (CN)

(21) Appl. No.: 19/647,005

(22) Filed: Apr. 14, 2026

(30) Foreign Application Priority Data
Apr. 24, 2025 (CN) 202510523568.X

(51) Int. Cl. G01V 1/34; E21F 17/18; G01V 1/30

(52) U.S. Cl. CPC G01V 1/345; E21F 17/18; G01V 1/303; G01V 2210/51

(57) ABSTRACT

A linear moveout correction and phase-delay focusing reverse-time migration method for tunnel seismic data includes following steps: step 1: eliminating the influence of offset using a linear moveout correction method, converting single-shot tunnel seismic records into self-excited and self-received data, and converting the corresponding shot locations to new locations; step 2: during forward extrapolation and reverse-time extrapolation, assigning phase delays sequentially to a wavelet and self-excited and self-received data according to a location of seismic trace to perform reverse-time migration (RTM) imaging; and step 3: weighting and stacking the RTM imaging results using signal-to-noise ratio statistics to obtain final focusing RTM imaging results. The present disclosure aims to overcome the influences of small offsets, distinguish the types and spatial structural characteristics of unfavorable geological bodies, and improve the accuracy of RTM imaging.

### CROSS-REFERENCE TO RELATED APPLICATIONS

This application claims priority to Chinese Patent Application No. 202510523568.X, filed on Apr. 24, 2025, the content of which is incorporated herein by reference in its entirety.

### TECHNICAL FIELD

The present disclosure relates to the technical field of tunnel seismic detection and engineering survey, in particular to a linear moveout correction and phase-delay focusing reverse-time migration method for tunnel seismic data.

### BACKGROUND

Tunnel seismic advance prediction methods are among one of the most effective geophysical methods for long-distance geological hazard prediction within tunnels. It can accurately predict geological anomalies 100 m to 150 m in a direction ahead of a tunnel face, including fault fracture zones, karst caves, weak rock strata, and water-rich zones. Migration imaging is one of the core techniques for tunnel seismic data processing. A narrow space within tunnels limits the acquisition of tunnel seismic data, resulting in data characterized by small offsets, multiple components, and limited data volume. Many researchers have studied tunnel seismic migration imaging methods. Ashida et al. (2001), based on scattering superposition theory, proposed the isochronous migration method, which enables rapid imaging but with relatively low imaging accuracy. Luth et al. (2005) restricted the Kirchhoff migration operator to the Fresnel zone volume along the reflection path, thereby improving imaging accuracy for tunnel seismic data with small offset apertures. Compared with Kirchhoff migration methods, the reverse-time migration (RTM) method employs the cross-correlation principle between forward extrapolation and reverse-time extrapolation for imaging. The imaging region is not limited by offset aperture, making the RTM method become the one with the highest imaging accuracy to date, particularly suitable for tunnel seismic data with small offsets. Applications of the RTM method in tunnel seismic data are still limited, with most research focusing on surface seismic data processing.

Many researchers have studied the RTM method for surface applications, achieving breakthroughs in imaging theory, imaging conditions, and calculation speed, and obtaining satisfactory results in practical applications. For example, Chang et al. (1986) proposed the excitation-time imaging condition for RTM. Mulder et al. (2004) found that iterative migration can reduce migration artifacts in RTM. Yan et al. (2008) extended the conditions for cross-correlation imaging, and proposed elastic wave imaging for angular domain analysis. Fletcher et al. (2009) implemented acoustic RTM in tilted transverse isotropic (TTI) media. Liu et al. (2015) utilized multiple waves to improve the accuracy of RTM imaging. Multiple waves can enhance the illumination of target, and reduce the impact of false anomalies. Silvestrov et al. (2016) implemented post-stack RTM imaging. High-performance computing techniques such as GPU (Liu et al., 2010) and FPGA (Medeiros et al., 2013) have also been applied to improve RTM calculation efficiency. Zha et al. (2018) achieved RTM imaging of 2D elastic wave equation for tunnel velocity models. Zou et al. (2021) proposed a passive-source RTM method for imaging 3D complex structures.

Although RTM has developed from 2D to 3D, the problem of small offset remains unsolved. Considering in-situ tunnel excavation conditions and the principles of seismic wave extrapolation within tunnel spaces, the present disclosure provides a linear moveout correction and phase-delay focusing reverse-time migration method for tunnel seismic data. The method aims to focus the RTM imaging range, suppress low-frequency noise interference, improve migration imaging accuracy, and thereby enhance the accuracy of tunnel seismic advance prediction.

### SUMMARY

In view of at least one defect in the prior art, the present disclosure provides a linear moveout correction and phase-delay focusing reverse-time migration method for tunnel seismic data, aiming to better overcome the influences of small offsets, distinguish the types and spatial structural characteristics of unfavorable geological bodies, and improves the accuracy of reverse-time migration (RTM) imaging.

In order to achieve the above objective, the present disclosure adopts the following technical solutions:
a linear moveout correction and phase-delay focusing reverse-time migration method for tunnel seismic data includes the following steps:
step 1: acquiring tunnel seismic data using a tunnel seismic prediction (TSP) observation system, picking first-arrival traveltime of the tunnel seismic data, and calculating an average velocity (v) of a surrounding rock using a least-squares fitting method;
step 2: preprocessing the tunnel seismic data, and extracting reflection wave records (RC) in an advancing direction;
step 3: using the velocity (v) as a linear moveout correction velocity based on the step 2, performing the linear moveout correction on the reflection wave records (RC) to eliminate the influence of offset, and correcting single-shot records into self-excited and self-received seismic records (RE) with zero offset;
step 4: converting the self-excited and self-received seismic records (RE) into seismic records (REA) with different phase delays based on the step 3;
step 5: performing phase-delay focusing RTM imaging based on the step 4, wherein a Ricker wavelet phase delay corresponds to a given delay during the calculation of forward extrapolation, and an input wavefield is the seismic records (REA) with different phase delays; and calculating focusing RTM imaging results by using cross-correlation imaging conditions; and
step 6: repeating the process of the step 5, assigning phase delays sequentially with different intervals Δtᵢ (i=1, 2, . . . , m, m may be regarded as a number of scanning and stacking times) for reverse-time migration, and weighing and stacking the resulting RTM images using signal-to-noise ratio (SNR) statistics to obtain final phase-delay focusing RTM imaging results.

In the step 2, the tunnel seismic data are preprocessed sequentially using band-pass filtering, automatic gain control, geometrical spreading correction, F-K filtering, and adaptive polarization filtering.

In the step 3, a time calculation formula for the linear moveout correction is as follows:

$${t}_{lmo}^{k} = \sqrt{{t}_{0}^{2} + {( {offset}^{k} / v )}^{2}} ; \qquad ( 1 )$$

$${t}_{l m o}^{k}$$

denotes time after the linear moveout correction, to denotes time of original tunnel seismic records, offset^{k} denotes a distance between a geophone and a shot point, v denotes a velocity for the linear moveout correction and is also a velocity obtained by fitting the first-arrival traveltime in the step 1. After the linear moveout correction time is calculated, single-shot records (RC) are corrected to self-excited and self-received seismic records (RE), with a calculation formula as follows:

$$R E ( {x}_{k} , t + {t}_{lmo}^{k} ) = R C ( x {1}_{k} , t ) ; \qquad ( 2 )$$

x1ₖ denotes an actual position of each trace in the single-shot records (RC), xₖ denotes an actual position of each trace in the self-excited and self-received seismic records (RE), with k=1, 2, . . . , N, where N denotes a number of traces in the tunnel seismic records. The purpose of the linear moveout correction is to eliminate the influence of offset.

The step 4 includes: assuming that the tunnel seismic records contain N traces, determining an equal time delay interval Δt, with a delay applied to a first trace being 0, a delay applied to a second trace being Δt, and a delay applied to an N^{th} trace being (N−1)×Δt, determining different delay values Δtᵢ (i=1, 2, . . . , m), and correcting to the corresponding tunnel seismic records (REAᵢ) (i=1, 2, . . . , m); m is a number of scanning and stacking times.

In the step 4, a derivation formula for the phase-delay method is as follows:

$$REA ( {x}_{2 k} , t + ( k - 1 ) Δ {t}_{i} ) = R E ( {x}_{k} , t ) ; \qquad ( 3 )$$

x₂ₖ denotes an actual position of a trace gather after the linear moveout correction, t denotes a time moment, and Δtᵢ denotes a phase delay.

In the step 5, a correction formula for wavelet phase delay applied during forward extrapolation of the phase-delay focusing reverse-time migration is as follows:

$$CRW ( {x}_{2 k} , t + ( k - 1 ) Δ {t}_{i} ) = R W ( t ) ; \qquad ( 4 )$$

RW denotes a Ricker wavelet, and CRW denotes a corrected Ricker wavelet.

During forward extrapolation and reverse-time extrapolation of RTM, the corrected wavelet CRW and the tunnel seismic records (REA) are respectively used as the input wavefield to start iterative calculations. The RTM imaging results are obtained using the cross-correlation imaging conditions, with a calculation formula as follows:

$$RESULT ( x , z ) = {\sum }_{t} Scontinuation ( x , z , t ) Rcontinuation ( x , z , t ) ; \qquad ( 5 )$$

Scontinuation(x, z, t) denotes a forward extrapolation wavefield at a spatial location (x,z) at different time moments t. Rcontinuation(x, z, t) denotes a reverse-time extrapolation wavefield at the spatial location (x,z) at different time moments t. RESULT(x, z) denotes RTM results.

In the step 6, a calculation formula for weighing and stacking the resulting RTM images using signal-to-noise ratio (SNR) statistics is as follows:

$$Y = \frac{1}{m} {\sum }_{i = 1}^{m} {\sum }_{k = 1}^{N} {\sum }_{j = 1}^{s} {w}^{i} ( j , k ) RESUL {T}^{i} ( j , k ) ; \qquad ( 6 )$$

S denotes a number of samples per trace in the RTM data, wⁱ(j, k) denotes a weight, whose specific value is positively correlated with the SNR statistics of the RTM data. Regions with high SNR are assigned larger weights, while regions with low SNR are assigned smaller weights. A sum of the weights is m, with a specific calculation formula as follows:

$${\sum }_{i = 1}^{m} {\sum }_{k = 1}^{N} {\sum }_{j = 1}^{s} {w}^{i} ( j , k ) = m . \qquad ( 7 )$$

The present disclosure provides a linear moveout correction and phase-delay focusing reverse-time migration method for tunnel seismic data, which can better overcome the influences of small offsets, distinguish the types and spatial structural characteristics of unfavorable geological bodies, and improve the accuracy of RTM imaging.

### BRIEF DESCRIPTION OF THE DRAWINGS

FIG. 1 illustrates a karst cave model.

FIG. 2A illustrates full-wavefield records; FIG. 2B illustrates TSP wavefield records; and FIG. 2C illustrates linear moveout correction records of TSP wavefield records.

FIGS. 3A-3D illustrates snapshots of wavefields at 7 ms, where FIG. 3A illustrates a forward extrapolation section of a conventional RTM method; FIG. 3B illustrates a forward extrapolation section of a focusing RTM method; FIG. 3C illustrates a reverse time extrapolation section of a conventional RTM method; and FIG. 3D illustrates a reverse time extrapolation section of a focusing RTM method.

FIGS. 4A-4B illustrates comparison of reverse-time migration results for a cave model, where FIG. 4A illustrates a conventional RTM method; and FIG. 4B illustrates a focusing RTM method.

FIG. 5 is a flowchart of a method according to the present disclosure.

### DETAILED DESCRIPTION OF THE EMBODIMENTS

The present disclosure will be further described below with reference to the accompanying drawings and the particular embodiments.

The present disclosure relates to a linear moveout correction and phase-delay focusing reverse-time migration method for tunnel seismic data, which can better overcome the influences of small offsets, distinguish the types and spatial structural characteristics of unfavorable geological bodies, and improve the accuracy of RTM imaging.

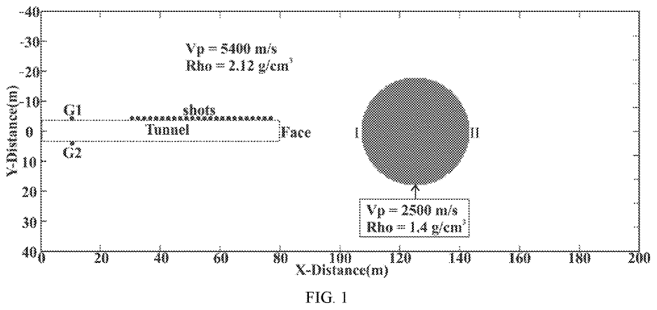

As shown in FIGS. 1-5, the present disclosure adopts the following technical solutions.

A linear moveout correction and phase-delay focusing reverse-time migration method for tunnel seismic data is provided. Specifically, a linear moveout correction method is adopted to eliminate the influence of offset, single-shot tunnel seismic records are converted into self-excited and self-received data, and the corresponding shot locations are also converted to new locations. Subsequently, during forward extrapolation and reverse-time extrapolation, phase delays are assigned sequentially to a wavelet and self-excited and self-received data according to a location of seismic trace to perform reverse-time migration (RTM) imaging. Finally, the RTM imaging results are weighted and stacked using signal-to-noise ratio statistics to obtain final focusing RTM imaging results.

A time calculation formula for the linear moveout correction is as follows:

$${t}_{lmo}^{k} = \sqrt{{t}_{0}^{2} + {( {offset}^{k} / v )}^{2}} ; \qquad ( 1 )$$

$${t}_{lmo}^{k}$$

denotes time after the linear moveout correction, to denotes time of original tunnel seismic records, offset^{k} denotes a distance between a geophone and a shot point, v denotes a velocity for the linear moveout correction and is a velocity obtained by fitting the first-arrival travel-time. After the linear moveout correction time is calculated, single-shot records (RC) corrected to self-excited and self-received seismic records (RE), with a calculation formula as follows:

$$R E ( {x}_{k} , t + {t}_{lmo}^{k} ) = R C ( x {1}_{k} , t ) ; \qquad ( 2 )$$

x1ₖ denotes an actual position of each trace in the single-shot records (RC), xₖ denotes an actual position of each trace in the self-excited and self-received seismic records (RE), with k=1, 2, . . . , N, where N denotes a number of traces in the tunnel seismic records. The purpose of the linear moveout correction is to eliminate the influence of offset.

A derivation formula for the phase-delay method is as follows:

$$REA ( {x}_{2 k} , t + ( k - 1 ) Δ {t}_{i} ) = R E ( {x}_{k} , t ) ; \qquad ( 3 )$$

x₂ₖ denotes an actual position of a trace gather after the linear moveout correction, t denotes a time moment, Δtᵢ denotes a phase delay, where i=1, 2, . . . , m, and m a number of scanning and stacking times.

A correction formula for wavelet phase delay applied during forward extrapolation of the phase-delay focusing reverse-time migration is as follows:

$$CRW ( {x}_{2 k} , t + ( k - 1 ) Δ {t}_{i} ) = R W ( t ) ; \qquad ( 4 )$$

RW denotes a Ricker wavelet, and CRW denotes a corrected Ricker wavelet.

During forward extrapolation and reverse-time extrapolation of RTM, the corrected wavelet CRW and the tunnel seismic records (REA) are respectively used as the input wavefield to start iterative calculations. The RTM imaging results are obtained using the cross-correlation imaging conditions, with a calculation formula as follows:

$$RESULT ( x , z ) = {\sum }_{t} Scontinuation ( x , z , t ) Rcontinuation ( x , z , t ) ; \qquad ( 5 )$$

Scontinuation(x, z, t) denotes a forward extrapolation wavefield at a spatial location (x,z) at different time moments t. Rcontinuation(x, z, t) denotes a reverse-time extrapolation wavefield at the spatial location (x,z) at different time moments t. RESULT(x, z) denotes RTM results.

A calculation formula for weighing and stacking the resulting RTM images using signal-to-noise ratio (SNR) statistics is as follows:

$$Y = \frac{1}{m} {\sum }_{i = 1}^{m} {\sum }_{k = 1}^{N} {\sum }_{j = 1}^{s} {w}^{i} ( j , k ) RESUL {T}^{i} ( j , k ) ; \qquad ( 6 )$$

where m denotes a number of scanning stacks, N denotes a number of traces, and S denotes a number of samples per trace in the RTM data. In the formula (6), 1/m is equivalent to normalizing to a value between 0 and 1, wⁱ(j,k) denotes a weight, whose specific value is positively correlated with the SNR statistics of the RTM data. Regions with high SNR are assigned larger weights, while regions with low SNR are assigned smaller weights. A sum of the weights is m, with a specific calculation formula as follows:

$${\sum }_{i = 1}^{m} {\sum }_{k = 1}^{N} {\sum }_{j = 1}^{s} {w}^{i} ( j , k ) = m . \qquad ( 7 )$$

The present disclosure has the following specific advantages.

Firstly, the velocity used for linear moveout correction has a high accuracy, enabling the linear moveout correction processing of tunnel seismic data to effectively eliminate the influence of offset.

Secondly, the method can achieve phase-delay focusing RTM imaging of unfavorable geological bodies without increasing seismic acquisition costs at tunnel construction sites.

Lastly, the phase-delay focusing RTM method can better overcome the influences of small offsets, distinguish the types and spatial structural characteristics, and improve the detection accuracy of unfavorable geological bodies.

In the present disclosure, the extrapolation process of elastic wave in a three-dimensional tunnel environment is simplified to a two-dimensional model, and the elastic wave is simplified to a sound wave. A novel phase-delay focusing RTM imaging method is proposed. By changing specific phase delays in the wavefield during forward extrapolation and reverse-time extrapolation, the method enhances the focusing of the RTM image and improves the detection accuracy of unfavorable geological bodies in the advancing direction.

The phase-delay focusing RTM imaging method falls within the scope of protection of the present disclosure, and is not limited to the two-dimensional model described herein, and the three-dimensional phase-delay focusing RTM imaging methods also fall within the scope of protection of the present disclosure.

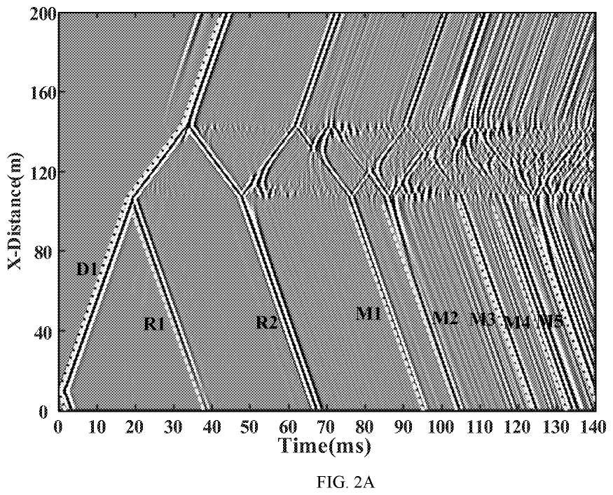

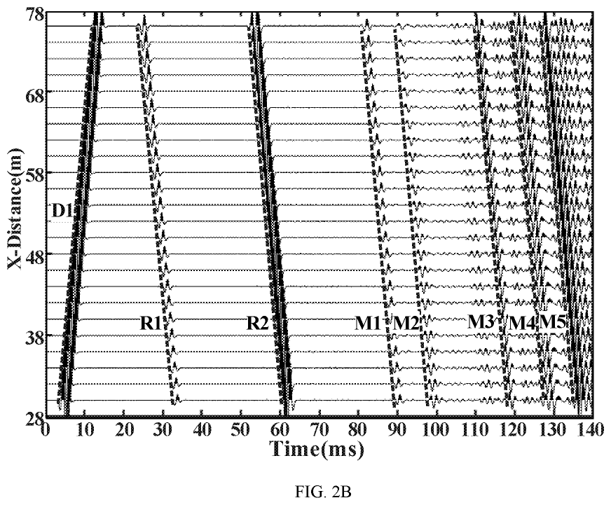

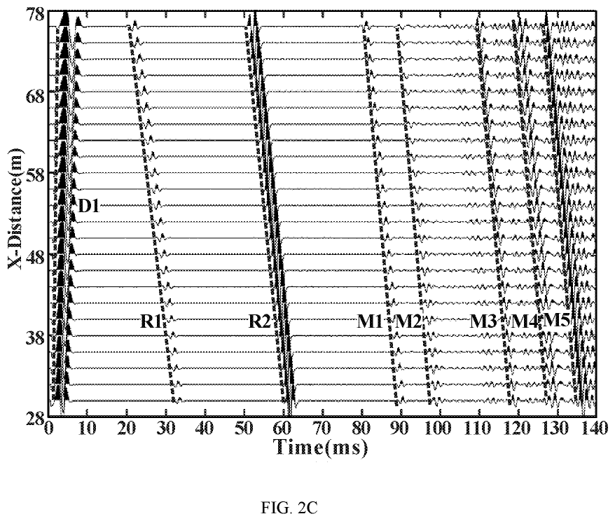

To verify the effectiveness of the method of the present disclosure, a two-dimensional karst cave model was designed, as shown in FIG. 1. Numerical simulation and reverse-time migration (RTM) were performed using a two-dimensional acoustic wave equation. G1 and G2 are positions of two geophones, and “shots” represent a total of 24 shot points. A surrounding rock has a P-wave velocity (Vp) of 5,400 m/s, and a density (Rho) of 2.12 g/cm³. The karst cave has a diameter of 36 m, with a P-wave velocity of 2,500 m/s and a density of 1.4 g/cm³. A data sampling interval is 35 μs, and each trace contains 4,000 sampling points. Data of 24 shots were simulated, and acoustic signals were recorded at the locations of G1 and G2. The acoustic signals received by the G1 geophone are shown in FIG. 2. A symbol D1 represents a direct wave, R1 and R2 represent reflected waves from Interfaces I and II, respectively, and M1-M5 are multiple waves. FIG. 2A illustrates full-wavefield records, with a lateral range from 0 m to 200 m, and a Y-direction vertical position is the same as G1 (see FIG. 1). FIG. 2B illustrates the extracted 24-shot tunnel seismic prediction (TSP) records. The linear moveout correction was applied using a velocity of 5,400 m/s, resulting in the corrected records shown in FIG. 2C.

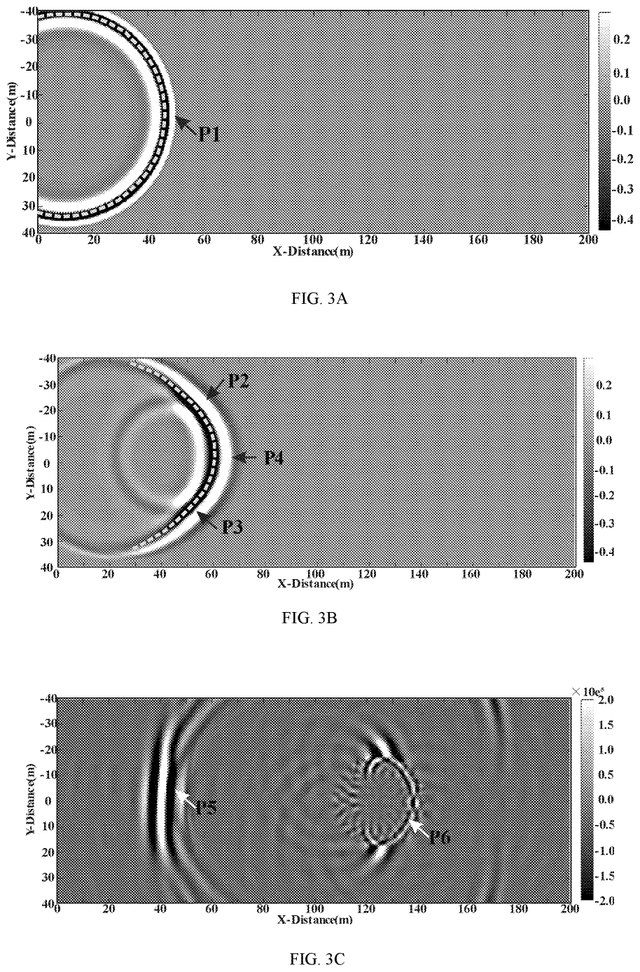

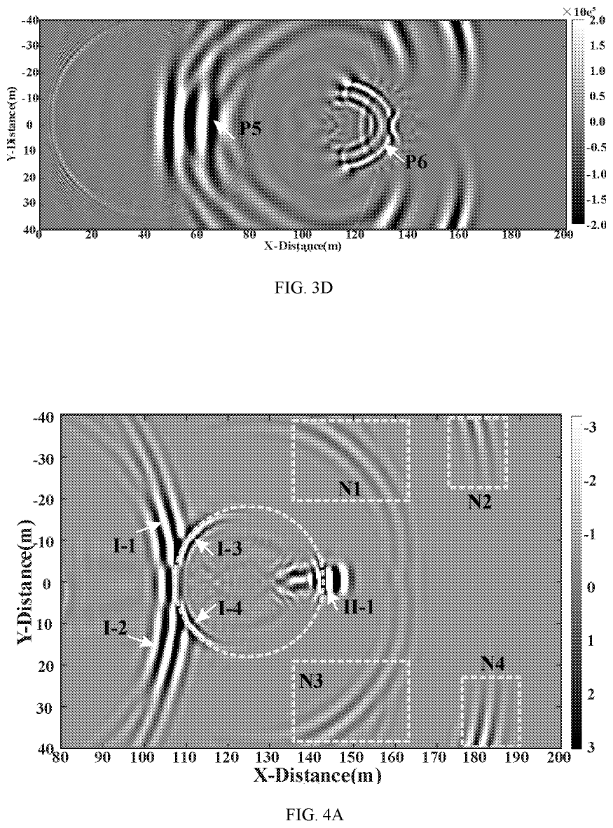

To visually demonstrate the effect of the focusing RTM method, snapshots of wavefields at 7 ms for both forward extrapolation and reverse-time extrapolation were extracted, as shown in FIGS. 3A-3D. FIG. 3A and FIG. 3B are snapshots of wavefields at 7 ms for forward extrapolation of a conventional RTM method and a focusing RTM method, respectively. P1-P3 represent wavefronts of reflected waves; P1 is approximately semicircular, energy of P2 and P3 begins to weaken, and P4 is enhanced. FIG. 3C and FIG. 3D are snapshots of wavefields at 7 ms for reverse-time extrapolation of a conventional RTM method and a focusing RTM method, respectively. P5 and P6 represent wavefronts of reflected waves, and compared with FIG. 3C, energy of P5 and P6 in FIG. 3D is stronger and more pronounced.

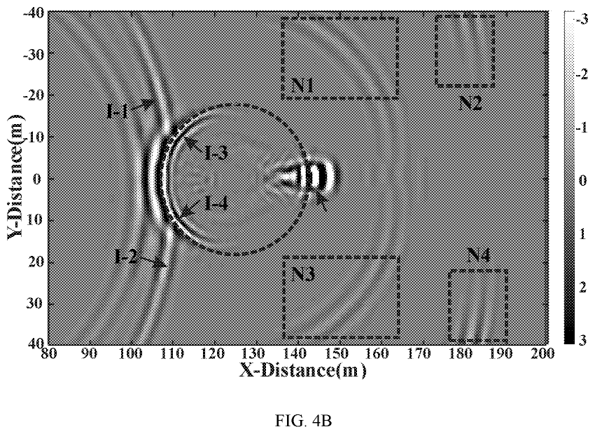

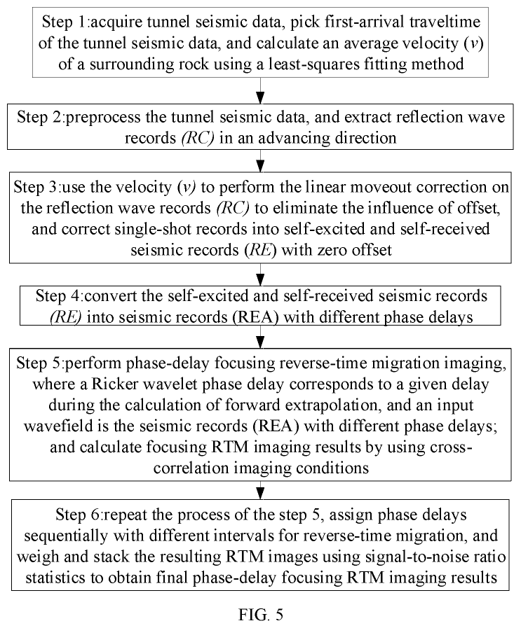

The imaging results obtained using the conventional RTM method and the focusing RTM method are shown in FIG. 4A and FIG. 4B. I-1 and I-2 correspond to strong reflective interfaces of Interface I, and II-1 corresponds to a strong reflective interface of Interface II. N1-N4 represent artifact noise. Compared with FIG. 4A, the imaging of the cave Interface I in FIG. 4B is more concentrated, making it easier to identify the structural features of the cave, especially, I-3 and I-4 clearly delineate the interface outline of the cave. Artifact noise in FIG. 4B is also weaker, with the most significant reduction observed at N4.

The numerical simulation results demonstrate that the focusing RTM imaging method can more clearly display the structural features of the karst cave, effectively suppress artifact noise, and enhance the resolution of the karst cave anomalies.

The methods of the present disclosure are mainly applied in the field of tunnel seismic advance predication.

Finally, it should be noted that the above description illustrates only specific embodiments of the present disclosure. Those skilled in the art may make various modifications and variations without departing from the scope of the present disclosure. Such modifications and variations that fall within the scope of the appended claims and their equivalents should be regarded as being covered by the scope of protection of the present disclosure.

What is claimed is:

1. A linear moveout correction and phase-delay focusing reverse-time migration method for tunnel seismic data, comprising following steps:
step 1: acquiring tunnel seismic data using a tunnel seismic prediction (TSP) observation system, picking first-arrival traveltime of the tunnel seismic data, and calculating an average velocity v of a surrounding rock using a least-squares fitting method;
step 2: preprocessing the tunnel seismic data, and extracting reflection wave records RC in an advancing direction;
step 3: using the velocity v as a linear moveout correction velocity, performing the linear moveout correction on the reflection wave records RC to eliminate the influence of offset, and correcting single-shot records into self-excited and self-received seismic records RE with zero offset;
step 4: converting the self-excited and self-received seismic records RE into seismic records REA with different phase delays;
step 5: performing phase-delay focusing reverse-time migration (RTM) imaging, wherein a Ricker wavelet phase delay corresponds to a given delay during the calculation of forward extrapolation, and an input wavefield is the seismic records REA with different phase delays; and
calculating focusing RTM imaging results by using cross-correlation imaging conditions; and
step 6: repeating the process of the step 5, assigning phase delays sequentially with different intervals Δtᵢ for reverse-time migration, and weighing and stacking the resulting RTM images using signal-to-noise ratio (SNR) statistics to obtain final phase-delay focusing RTM imaging results.

2. The linear moveout correction and phase-delay focusing reverse-time migration method for tunnel seismic data according to claim 1, wherein in the step 2, the tunnel seismic data are preprocessed sequentially using band-pass filtering, automatic gain control, geometrical spreading correction, F-K filtering, and adaptive polarization filtering.

3. The linear moveout correction and phase-delay focusing reverse-time migration method for tunnel seismic data according to claim 1, wherein in the step 3, a time calculation formula for the linear moveout correction is as follows:
$${t}_{lmo}^{k} = \sqrt{{t}_{0}^{2} + {( \frac{{offset}^{k}}{v} )}^{2}} ; \qquad ( 1 )$$
tunnel
$${t}_{lmo}^{k}$$
denotes time after the linear moveout correction, t₀ denotes time of original tunnel seismic records, offset^{k} denotes a distance between a geophone and a shot point, v denotes a velocity for the linear moveout correction and is a velocity obtained by fitting the first-arrival traveltime in the step 1; and correcting the single-shot records RC into the self-excited and self-received seismic records RE after the linear moveout correction time is calculated, with a calculation formula as follows:
$$R E ( {x}_{k} , t + {t}_{lmo}^{k} ) = R C ( x {1}_{k} , t ) ; \qquad ( 2 )$$
wherein x1ₖ denotes an actual position of each trace in the single-shot records RC, xₖ denotes an actual position of each trace in the self-excited and self-received seismic records RE, with k=1, 2, . . . , N, and N denotes a number of traces in the tunnel seismic records.

4. The linear moveout correction and phase-delay focusing reverse-time migration method for tunnel seismic data according to claim 3, wherein the step 4 comprises:
assuming that the tunnel seismic records comprise N traces, determining an equal time delay interval Δt, with a delay applied to a first trace being 0, a delay applied to a second trace being Δt, and a delay applied to an N^{th} trace being (N−1)×Δt, determining different delay values Δtᵢ, respectively, with i=1, 2, . . . , m, and m is a number of scanning and stacking times; and
correcting to the corresponding tunnel seismic records REAᵢ, with i=1, 2, . . . , m.

5. The linear moveout correction and phase-delay focusing reverse-time migration method for tunnel seismic data according to claim 4, wherein in the step 4, a derivation formula for the phase-delay method is as follows:
$$REA ( {x}_{2 k} , t + ( k - 1 ) Δ {t}_{i} ) = R E ( {x}_{k} , t ) ; \qquad ( 3 )$$
wherein x₂ₖ denotes an actual position of a trace gather after the linear moveout correction, and t denotes a time moment.

6. The linear moveout correction and phase-delay focusing reverse-time migration method for tunnel seismic data according to claim 5, wherein in the step 5, a correction formula for wavelet phase delay applied during forward extrapolation of the phase-delay focusing reverse-time migration is as follows:
$$CRW ( {x}_{2 k} , t + ( k - 1 ) Δ {t}_{i} ) = R W ( t ) ; \qquad ( 4 )$$
wherein RW denotes a Ricker wavelet, and CRW denotes a corrected Ricker wavelet; during forward extrapolation and reverse-time extrapolation of RTM, the corrected wavelet CRW and the tunnel seismic records REA are respectively used as the input wavefield to start iterative calculations; and RTM imaging results are obtained using the cross-correlation imaging conditions, with a calculation formula as follows:
$$RESULT ( x , z ) = {\sum }_{t} Scontinuation ( x , z , t ) Rcontinuation ( x , z , t ) ; \qquad ( 5 )$$
wherein Scontinuation(x, z, t) denotes a forward extrapolation wavefield at a spatial location (x,z) at different time moments t; Rcontinuation(x, z, t) denotes a reverse-time extrapolation wavefield at the spatial location (x,z) at different time moments t; and RESULT(x, z) denotes RTM results.

7. The linear moveout correction and phase-delay focusing reverse-time migration method for tunnel seismic data according to claim 6, wherein in the step 6, a calculation formula for weighing and stacking the resulting RTM images using SNR statistics is as follows:
$$Y = \frac{1}{m} {\sum }_{i = 1}^{m} {\sum }_{k = 1}^{N} {\sum }_{j = 1}^{s} {w}^{i} ( j , k ) RESUL {T}^{i} ( j , k ) ; \qquad ( 6 )$$
wherein S denotes a number of samples per trace in the RTM data; wⁱ(j,k) denotes a weight, and a sum of the weights is m, with a calculation formula as follows:
$${\sum }_{i = 1}^{m} {\sum }_{k = 1}^{N} {\sum }_{j = 1}^{s} {w}^{i} ( j , k ) = m . \qquad ( 7 )$$
